(19) United States
(12) Patent Application Publication
(10) Pub. No.: US 2010/0080018 A1
(43) Pub. Date: Apr. 1, 2010

(54) COMPENSATING LIGHT GUIDE

(75) Inventor: Theodorus Franciscus Emilius Maria Overes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,232

(22) PCT Filed: Dec. 3, 2007
(86) PCT No.: PCT/IB2007/054893

§ 371 Date: Jun. 2, 2009

(30) Foreign Application Priority Data
Dec. 7, 2006 (EP) 06125642.6

(51) Int. Cl. F21V 8/00; F21V 9/08

(52) U.S. Cl. 362/583; 362/293

(57) ABSTRACT

The invention relates to a compensating light guide (10) for guiding visible light (20) from a light source (100). The light guide has a first transmission region (1TR), where light is guided from the light source along a first optical path (1OP), and a second transmission region (2TR), where light is guided from the light source along a second optical path (2OP). The light guided along the second optical path has a larger absorption in a first sub band resulting in an absorption difference between the first and the second optical path. The first (1TR) and second (2TR) transmission regions are optically arranged to transmit light so as to relatively reduce a second sub band of the first spectral distribution. The relative reduction between the first (1TR) and second (2TR) transmission regions is proportionated so as to psycho-visually compensate the absorption difference in the light guide (10) resulting in a uniform color emitted from the light guide (10) as perceived by a viewer (200).

### FIELD OF THE INVENTION

The present invention relates to a compensating light guide for guiding visible light, the light guide being optically arranged for emitting a substantially uniform color. The invention also relates to a lighting system with a lighting source and a compensating light guide. Furthermore, the invention relates to a method for guiding light through a light guide.

### BACKGROUND OF THE INVENTION

For many practical applications within the field of lighting, light is required to spread out over a large area or length. This can be achieved by concentrated light sources (e.g. incandescent lamps) positioned at some distance of the area to be lighted, or by using light sources that already have a significant size (like TL tubes). With the recent improvements of light emitting diodes (LED), the use of concentrated light sources will probably increase significantly. Because of the special properties of LEDs, they are also expected to be used to replace large size light sources, and many new applications will therefore arise for lighting.

It is expected that there will be an increasing wish to be able to spread out the light of concentrated light sources without needing to place the light unit at large distances. Also many applications it is preferred to concentrate the light in a selected area or direction, to increase the efficiency of the light system, and to reduce the disturbance by the undesired light. For this purpose, light guides are well suited. The directional light of LED's and their limited temperature increase during lighting make them ideal for being combined with light guides.

High transparency light guide materials are required, especially when the light has to travel over large distances inside the light guide, e.g. several meters. In case the light will be coupled out at different locations, with different optical distances to the light source, this transparency also has to be more or less uniform over the bandwidth of the visible light. This is necessary in order to avoid color differences at the different locations, which is not acceptable in many applications.

An example of such a light guide system is the cylindrical light guide design that has been developed for Philips' Ambilight® television system with the surrounding light being dependent on the current content being displayed on the television system. Presently, polymethyl methacrylate (PMMA) is used as light guide material as this material fulfils the transparency and uniformity requirements for this application. However, PMMA has some other disadvantages relevant for television systems. Replacement materials like glasses of various kinds can be found, but the transparency of the various commonly applied glasses is typically not sufficiently uniform over the bandwidth of the visible light causing an undesirable lack of uniformity with respect to color.

Hence, an improved light guide would be advantageous, and in particular a more efficient and/or reliable light guide would be advantageous.

### SUMMARY OF THE INVENTION

Accordingly, the invention preferably seeks to mitigate, alleviate or eliminate one or more of the above-mentioned disadvantages singly or in any combination. In particular, it may be seen as an object of the present invention to provide a light guide that solves the above mentioned problems of the prior art with uniform coloring of the light emitted from light guides.

This object and several other objects are obtained in a first aspect of the invention by providing a compensating light guide for guiding visible light emitted from an associated light source and for emitting a substantially uniform color, the associated light source being capable of emitting visible light of a first spectral distribution, the light guide having a substantially color-dependent absorption for visible light, the light guide comprising;

a first transmission region, where light guided from the light source along a first optical path is transmitted out of the light guide; and

a second transmission region, where light guided from the light source along a second optical path is transmitted out of the light guide, wherein the light guided along the second optical path has a larger absorption in at least a first sub band of the first spectral distribution relative to the light guided along the first optical path resulting in an absorption difference between the first and the second optical path,

wherein the first and second transmission regions are optically arranged to transmit light so as to relatively reduce a second sub band of the first spectral distribution, the relative reduction between the first and second transmission regions being proportionated so as to psycho-visually compensate, at least with respect to color, the absorption difference in the light guide.

The invention is particularly, but not exclusively, advantageous for obtaining a light guide capable of compensating the absorption difference at the various out-coupling positions of the light. This is obtained by relatively reducing the second sub band of the first spectral distribution, thereby more or less re-establishing the psycho-visual balance between the first and second sub bands, resulting in an improved uniform color perception from the light guide.

With respect to psycho-visual compensation provided by the light guide of the present invention, reference is made to the work of The International Commission on Illumination (usually known as the CIE for its French-language name Commission internationale de l'éclairage), in particular the relevant standards on color perception. In general, the CIE 1931 or CIE 1964 Standard Observer may be applied for assessing the technical effect of the present invention. Thus, in the CIE 1931 (1964) color matching functions are defining how the tri-stimulus values X, Y and Z can be derived from the spectrum of the light. It should be noted that perception of colors by different people will differ, and the above-mentioned standards have been based on experiments with a relatively small number of persons. It is however assumed that light with the same tri-stimulus value is perceived as the same light (same color and brightness) for defining only the color, the x and y derived from X, Y and Z are used.

Additionally, the relative reduction between the first and second transmission regions may be proportionated so that an external viewer experiences a perceived substantially equal color from the first and second transmission regions. Thus, the notion of a “viewer” should be defined according to an appropriate standard as for example mentioned above.

Advantageously, the first and second transmission regions may be further optically arranged to transmit light so as to relatively reduce a third sub band of the first spectral distribution, the third sub band being different from the second sub band, the relative reduction of the third sub band between the first and second transmission regions being proportionated so as to psycho-visually compensate, at least with respect to color, the absorption difference in the light guide. This is typically the case for practical implementations where the sub bands are not sharply defined but may be overlapping with the neighboring sub bands.

Typically, the first and second transmission regions may be a subset of a plurality of transmission regions, the plurality of transmission regions providing a graded relative reduction of the second sub band and/or the third sub band, the graded relative reduction being in proportion with the respective optical path to each transmission region of the light guide. Both with respect to length but also for two- and three-dimensional objects this may be implemented.

In one embodiment, the first and the second transmission region may be optically arranged so as to relatively reduce the second sub band and/or the third sub band of the first spectral distribution by absorption. This can be obtained e.g. by a pigment absorbing all but a specific sub band of light. In combination with a graded relative reduction of the second and/or third sub band, the graded relative reduction may be provided by an absorbing pigment, the pigment being arranged on the plurality of transitions regions in a graded pattern.

In another embodiment, the first and the second transmission region may be optically arranged for reducing a second sub band and/or the third sub band of the first spectral distribution by reflection. This can be obtained by a diffuse paint on a light guide that couples out the light. A mirror layer may then keep the light within the light guide.

Beneficially, the light guide may be made from glass such as B270, Duran, or AR glass. Typically, the first sub band may then comprise the red color of light (ca. 625-740 nm), whereas the second and third sub band may comprise the green (ca. 500-565 nm) and blue (440-485 nm) color of light. Often commonly applied glasses exhibits absorption around the color of red due to traces or impurities of iron in the glass.

In a second aspect, the invention relates to a compensating lighting system comprising a compensating light guide according to the first aspect of the invention, and a light source capable of emitting visible light of a first spectral distribution.

In one embodiment, the first and second transmission regions may be further optically arranged so as to relatively reduce the first sub band of the first spectral distribution, the relative reduction between the first and second transmission regions being proportionated so as to psycho-visually compensate, at least with respect to color, the absorption difference in the light guide. Additionally, wherein the light source may be adapted to at least partly compensate for the said absorption difference in the light guide by increasing the intensity of the first sub band of the first spectral distribution. The light source may comprise one or more light emitting diode (LED), possibly having each a separate color. Essentially, all kinds of light sources can be used such as: incandescent lamps, cold cathode fluorescent light (CCFL), TL-tubes, and so forth. Advantageously, the lighting system may be peripherally arranged to, at least a part of, a displaying or television system like an Ambilight® displaying system or similar systems.

In a third aspect, the invention relates to a method for compensating an absorption difference in a light guide, the light guide being arranged for guiding visible light emitted from a light source and for emitting a substantially uniform color, the light source being capable of emitting visible light of a first spectral distribution, the light guide having a substantially color-dependent absorption for visible light, the method comprising;

guiding light to a first transmission region, where light is transmitted out of the light guide along a first optical path,

guiding light to a second transmission region, where light is transmitted out of the light guide along a second optical path, wherein the light guided along a second optical path has a larger absorption in at least a first sub band of the first spectral distribution relative to the light guided along the first optical path resulting in an absorption difference between the first and the second optical path, and

optically arranging the first and second transmission regions so as to transmit light by relatively reducing a second sub band of the first spectral distribution, the relative reduction between the first and second transmission regions being proportionated so as to psycho-visually compensate, at least with respect to color, the absorption difference in the light guide.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 is a schematic drawing of a light guide and a light source according to the present invention,

FIG. 2 is a schematic graph of a first spectral distribution from the light source,

FIG. 3 is a schematic graph of the absorption and the resulting light at the end of the two different optical paths,

FIG. 4 is schematic graph of the two different transition characteristics of the first and second transition regions, and the resulting light emitted from the light guide according to the present invention,

FIG. 5 is a schematic drawing of a light guide with plurality of transitions regions,

FIGS. 6 and 7 comprise schematic drawings of patterns for providing a plurality of transitions regions, and

FIG. 8 is a flow-chart of a method according to the invention.

### DETAILED DESCRIPTION OF THE EMBODIMENTS

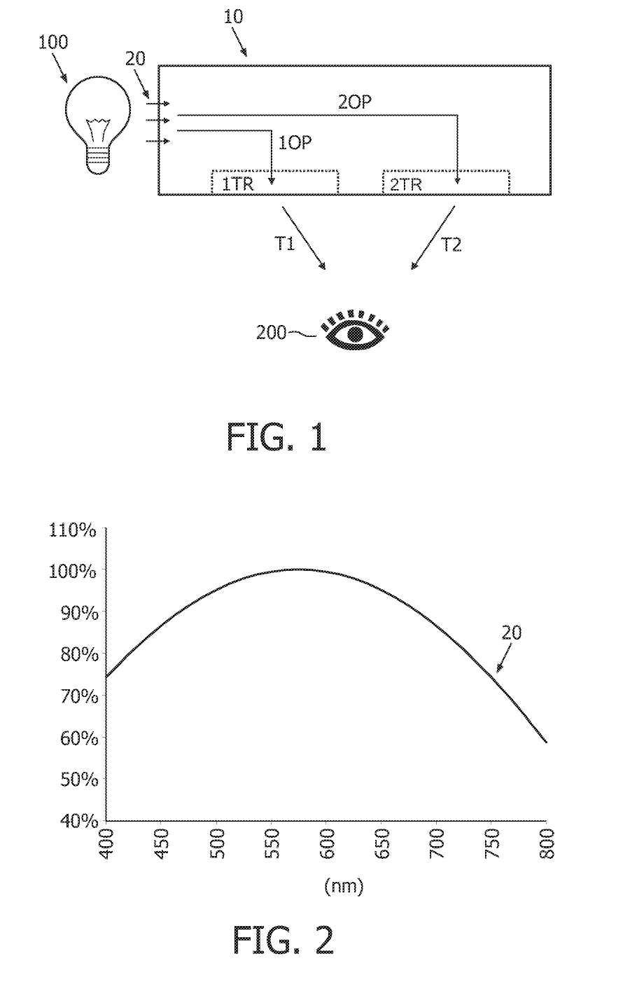

FIG. 1 is a schematic drawing of a light guide 10 and a light source 100 according to the present invention, the light source 100 being capable of emitting visible light 20 of a first spectral distribution, cf. FIG. 2 below. The light guide 10 has a substantially color-dependent absorption for visible light, i.e. light transmitted through the guide will experience dispersion.

The light guide 10 comprises a first transmission region 1TR, where light 20 guided from the light source 100 along a first optical path 1OP is transmitted out of the light guide 10, and a second transmission region 2TR, where light 20 guided from the light source 100 along a second optical path 2OP is transmitted out of the light guide 10. As indicated in FIG. 1, the light guided along the second optical path 2OP has a larger absorption in at least a first sub band of the first spectral distribution relative to the light guided along the first optical path 1OP due to the longer distance. This results in an absorption difference between the first and the second optical path. Thus, if the light guide is absorbing more of the color red, there will be less red color at the end of the second path 2OP.

The first 1TR and second 2TR transmission regions are optically arranged to transmit light T1 and T2, respectively, so as to relatively reduce a second sub band of the first spectral distribution, the relative reduction between the first 1TR and second 2TR transmission regions being proportionated so as to psycho-visually compensate, at least with respect to color, the absorption difference in the light guide 10.

FIG. 2 is a schematic graph of a first spectral distribution 20 from the light source 100, showing on the horizontal scale the wavelength of the light in nanometer (nm) and on the vertical scale the relative intensity. The continuous spectral distribution of FIG. 2 is not a representative spectral distribution, but merely provided to provide an explainary distribution for explaining the invention in a simple manner. However, the teaching of the invention can readily be extended to other spectral distributions of light. Visible light may be defined as electromagnetic radiation within the interval of 400-700 nm, alternatively 350-750 nm, or more alternatively 300-800 nm.

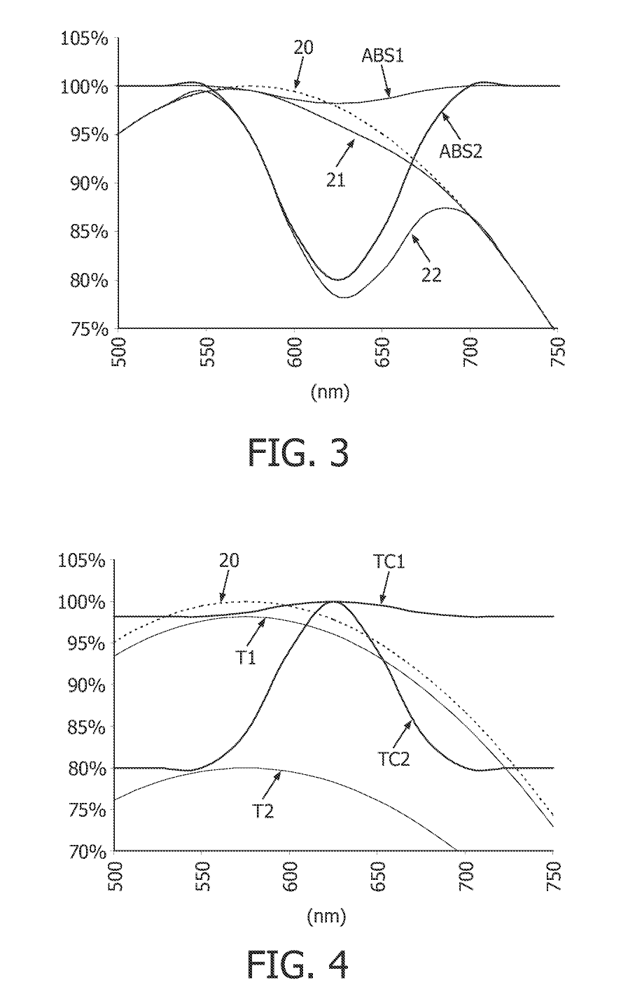

FIG. 3 is a schematic graph, similar to FIG. 2, of the absorption to which the light is subjected, ABS1 and ABS2, and the resulting light, 21 and 22, at the end of the two different optical paths, 1OP and 2OP, respectively. For comparison the first spectral distribution of the light 20 entering the light guide 10 is also shown with the dashed curve. The shorter optical path 1OP will have a relatively smaller absorption ABS1 as compared to the longer optical path 2OP where a larger absorption ABS2 is present. Notice that the vertical scale on the graph measures relative transmission (or intensity) in % meaning that absorption is largest when the relative transmission is lowest. As a result of this absorption difference, the light 21 at the end of the first optical path 1OP will have a slight attenuation as compared to 20, whereas the light 22 at the end of the second optical path 2OP will have a more significant attenuation. Due to the quite different spectral shape of 21 and 22, light T1 and T2 emitted from the first 1TR and second 2TR transmission region, respectively, would be perceived to have different color from one another if not compensated according to the present invention.

FIG. 4 is a schematic graph of the two different transition characteristics, TC1 and TC2, respectively, of the first 1TR and second 2TR transition regions, and the resulting light, T1 and T2, cf. FIG. 1, emitted from the light guide 10 according to the present invention. As indicated in FIG. 4, the light portions 21 and 22, cf. FIG. 3, arriving at the two transition regions are subjected to the different transition characteristics, TC1 and TC2, which result in the light portions T1 and T1 being emitted from the light guide 10. The light portions T1 and T2 have the same relative spectral distribution as the light 20 emitted into the light guide as seen in the graph of FIG. 4. Accordingly, the perceived color as seen by an outside viewer 200, FIG. 1, will be same, but the brightness reduction as a result of the absorption difference will be different for 1TR and 2TR. It should be noted that the intensity of the T1 and T2 are different from each other and lower than the original light 20.

Upon comparison of FIGS. 3 and 4, it is noted that the transition characteristics, TC1 and TC2 can be seen to have maxima where the absorption ABS1 and ABS1 were also largest (i.e. minimum in the relative transmission/intensity graph of FIG. 3).

With respect to the sub bands of the first spectral distribution 20, where a relative reduction takes place, it should also be noted that the first sub band has a center around 630 nm, i.e. the minima for the ABS1 and ABS1 curves, whereas the second and third sub band can be considered to be positioned below and above this center, and the second and third sub bands can be considered as over-lapping with the first sub band as no sharp transition is present in the absorption and transmission characteristics of the light guide 10 of this embodiment.

In a variation of the invention, the two different transition or out-coupling characteristics, TC1 and TC2, can be arranged so that the intensity of the emitted light T1 and T2 are substantially the same, preferably the same as perceived by a viewer 200.

In another variation of the invention, the two different transition or out-coupling characteristics, TC1 and TC2, can be arranged so that the perceived color of the emitted light T1 and T2 are substantially the same, but different from the perceived color of the light 20 emitted into the light guide 10.

In yet another variation of the invention, it may for some combinations of light guide materials and light sources be possible that only TC2 is implemented according to the present invention, thus TC1 is a constant, but the transition regions 1TR and 2TR can still be considered to perform—in combination—a relative reduction of a second sub band different from the first sub band where the absorption is largest.

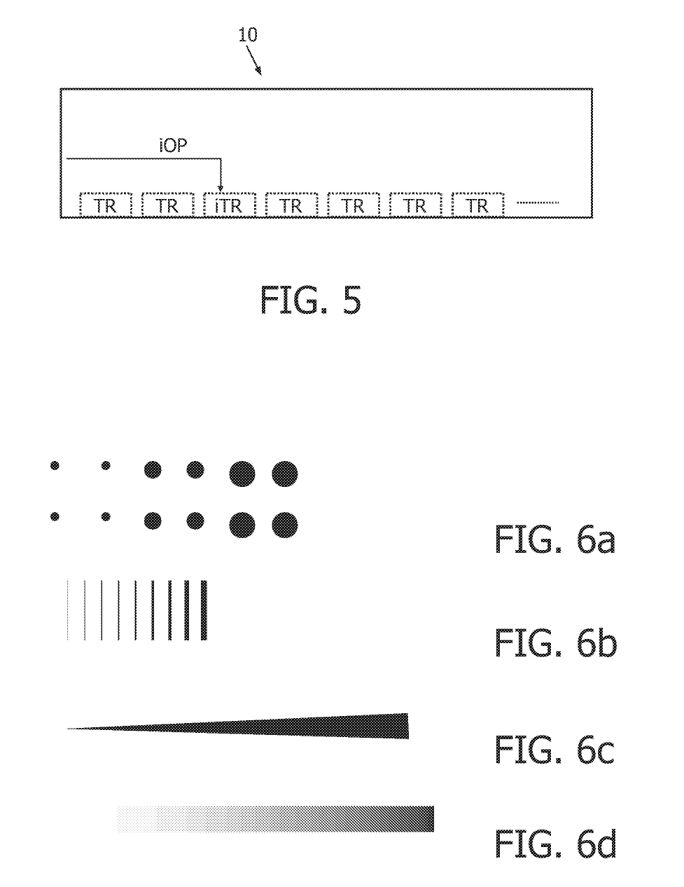

FIG. 5 is a schematic drawing of a light guide 10 with a plurality of transitions regions, each transition region iTR having a corresponding optical path iOP. The first 1TR and second 2TR transmission regions are accordingly only a subset of the plurality of transmission regions. The plurality of transmission regions provides a graded relative reduction of the second sub band and possibly a third sub band, the graded relative reduction being in proportion with the respective optical path iOP to each transmission region iTR of the light guide 10. This can be implemented for an essentially one-dimensional light guide, where the length to the light source is more or less the distance along the light guide, but it could also be implemented for a two-dimensional screen or a three-dimensional object.

Additionally, the teaching of the present invention is not limited to applications with only one light source 100 connected to the light guide 10. The teaching can be readily extended to applications where a plurality of light sources is connected to the light guide, e.g. each light source could have a separate color.

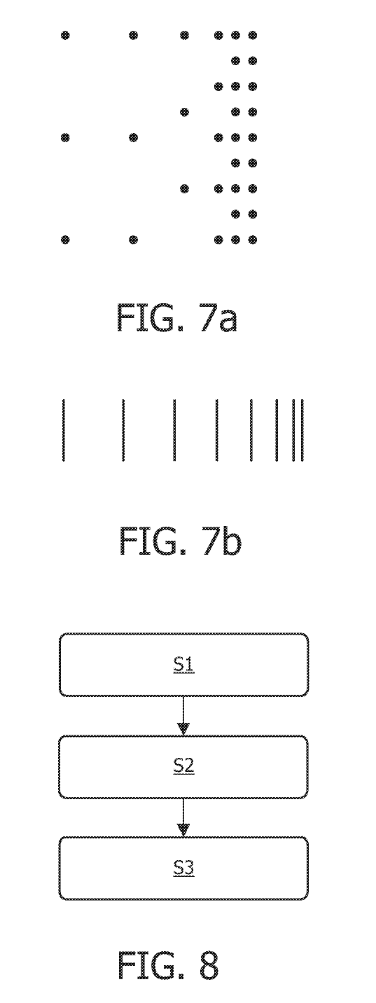

FIGS. 6 and 7 comprise schematic drawings of patterns for providing a plurality of transitions regions with a graded relative reduction according to the present invention with a colored pigment.

In FIG. 6a, a range of dots is increasing in size so as to provide a graded reduction. In FIG. 6b, a series of equidistant lines have an increasing width so as to provide a graded reduction.

FIG. 6c shows a line having a width that is increasing along the length of the line. FIG. 6d is similarly a line where a gradual filling effect with respect to the dot concentration per area is increasing along the length of the line. Such effect may in particular be provided by exploiting ink-jet technology in the coloring of the transition regions TR of the light guide 10.

FIG. 7a similarly shows a color dot pattern that has an increasing dot concentration per area from left to right, the pattern being capable of providing a graded relative reduction. FIG. 7b shows another variation, where lines of equal width are arranged in a pattern of decreasing inter-line distance, the pattern being capable of providing a graded relative reduction according to present invention.

FIG. 8 is a flow-chart of a method for compensating an absorption difference in a light guide 10, the light guide being arranged for guiding visible light emitted from a light source 100 and for emitting a substantially uniform color, the light source being capable of emitting visible light 20 of a first spectral distribution, the light guide having a substantially color-dependent absorption for visible light, the method comprising;

S1 guiding light to a first transmission region 1TR, where light is transmitted out of the light guide along a first optical path 1OP,

S2 guiding light to a second transmission region 2TR, where light is transmitted out of the light guide along a second optical path 2OP, wherein the light guided along a second optical path has a larger absorption in at least a first sub band of the first spectral distribution relative to the light guided along the first optical path resulting in an absorption difference between the first and the second optical path, and

S3 optically arranging the first 1TR and second 2TR transmission regions so as to transmit light by relatively reducing a second sub band of the first spectral distribution, the relative reduction between the first and second transmission regions being proportionated so as to psycho-visually compensate, at least with respect to color, the absorption difference in the light guide.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A compensating light guide (10) for guiding visible light (20) emitted from an associated light source (100) and for emitting a substantially uniform color, the associated light source being capable of emitting visible light (20) of a first spectral distribution, the light guide having a substantially color-dependent absorption for visible light, the light guide comprising;
a first transmission region (1TR), where light guided from the light source along a first optical path (1OP) is transmitted out of the light guide, and
a second transmission region (2TR), where light guided from the light source along a second optical path (2OP) is transmitted out of the light guide, wherein the light guided along the second optical path has a larger absorption in at least a first sub band of the first spectral distribution relative to the light guided along the first optical path resulting in an absorption difference between the first and the second optical path,
wherein the first and second transmission regions are optically arranged to transmit light so as to relatively reduce a second sub band of the first spectral distribution, the relative reduction between the first (1TR) and second (2TR) transmission regions being proportionated so as to psycho-visually compensate, at least with respect to color, the absorption difference in the light guide (10).

2. A compensating light guide according to claim 1, wherein the relative reduction between the first and second transmission regions is proportionated so that an external viewer (200) experiences a perceived substantially equal color from the first and second transmission regions.

3. A compensating light guide according to claim 1, wherein the first and second transmission regions are further optically arranged to transmit light so as to relatively reduce a third sub band of the first spectral distribution, the third sub band being different from the second sub band, the relative reduction of the third sub band between the first and second transmission regions being proportionated so as to psycho-visually compensate, at least with respect to color, the absorption difference in the light guide.

4. A compensating light guide according to claim 1, wherein the first and second transmission regions are a subset of a plurality of transmission regions (iTR), the plurality of transmission regions providing a graded relative reduction of the second sub band and/or the third sub band, the graded relative reduction being in proportion with the respective optical path (iOP) to each transmission region of the light guide.

5. A compensating light guide according to claim 1, wherein the first and the second transmission region is optically arranged so as to relatively reduce the second sub band and/or the third sub band of the first spectral distribution by absorption.

6. A compensating light guide according to claim 4, wherein the graded relative reduction is provided by an absorbing pigment, the pigment being arranged on the plurality of transition regions in a graded pattern.

7. A compensating light guide according to claim 1, wherein the first and the second transmission region are optically arranged for reducing the second sub band and/or the third sub band of the first spectral distribution by reflection.

8. A compensating light guide according to claim 1, wherein the light guide is made from glass.

9. A compensating lighting system comprising:
a compensating light guide (10) according to claim 1; and
a light source (100) capable of emitting visible light of a first spectral distribution.

10. A compensating lighting system according to claim 9, wherein the first (1TR) and second (2TR) transmission regions are further optically arranged so as to relatively reduce the first sub band of the first spectral distribution, the relative reduction between the first and second transmission regions being proportionated so as to psycho-visually compensate, at least with respect to color, the absorption difference in the light guide.

11. A compensating lighting system according to claim 10, wherein the light source (100) is adapted to at least partly compensate for the said absorption difference in the light guide by increasing the intensity of the first sub band of the first spectral distribution.

12. A compensating lighting system according to claim 9, wherein the light source (100) comprises a light emitting diode (LED).

13. A compensating lighting system according to claim 9, wherein the system is peripherally arranged to, at least a part of, a displaying system.

14. A method for compensating an absorption difference in a light guide (10), the light guide being arranged for guiding visible light emitted from a light source (100) and for emitting a substantially uniform color, the light source being capable of emitting visible light (20) of a first spectral distribution, the light guide having a substantially color-dependent absorption for visible light, the method comprising;
guiding light to a first transmission region (1TR), where light is transmitted out of the light guide along a first optical path (1OP),
guiding light to a second transmission region (2TR), where light is transmitted out of the light guide along a second optical path (2OP), wherein the light guided along a second optical path has a larger absorption in at least a first sub band of the first spectral distribution relative to the light guided along the first optical path resulting in an absorption difference between the first and the second optical path, and
optically arranging the first (1TR) and second (2TR) transmission regions so as to transmit light by relatively reducing a second sub band of the first spectral distribution, the relative reduction between the first and second transmission regions being proportionated so as to psycho-visually compensate, at least with respect to color, the absorption difference in the light guide.
